(19) United States
(12) Patent Application Publication
(10) Pub. No.: US 2003/0037232 A1
(43) Pub. Date: Feb. 20, 2003

(54) Encoding of universal resource locators in a security gateway to enable manipulation by active content

(76) Inventor: Crispin Bailiff, Erskineville (AU)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/130,013

(22) PCT Filed: Nov. 7, 2001
(86) PCT No.: PCT/AU01/01434

(30) Foreign Application Priority Data
Nov. 7, 2000 (AU) PR 1293

(51) Int. Cl. H04L 9/00

(52) U.S. Cl. 713/153

(57) ABSTRACT

A method of encoding a remote record identifier, such as a Universal Resource Locator, that maintains compatibility with active content by creating a new identifier from a base portion and a path and/or query portion. The remote record identifier is encrypted using suitable encryption techniques. The path and/or query portion is processed to produce a substitute path and/or query element for each path and/or query. The encrypted base portion and the substitute path and/or query elements are combined to form a composite encrypted remote record identifier and gateway parameters are added to form an encrypted rewritten record identifier. Also disclosed is a method of decrypting an encrypted rewritten record identifier and a gateway apparatus for mediating communication between a client system and a server system using the remote record identifier encryption and decryption methods

### FIELD OF THE INVENTION

The present invention relates to the field of interconnected computers, and more particularly to the field of gateways which facilitate data distributed on interconnected computers. The present invention is directed to a system which enhances the security of the data which is distributed.

### BACKGROUND OF THE INVENTION

The World Wide Web (WWW) is one of the most popular applications of the Internet today. The WWW provides a mechanism for the distribution of information in many different forms, such as Hypertext Markup Language (HTML), Wireless Markup Language (WML), Extensible Markup Language-(XML), Page Description Format (PDF) as well as images, sounds, video and various application formats (wordprocessing files, spreadsheets etc.).

HTML, WML, XML, PDF and many other of these information formats can contain ‘links’ (pointers) to other information contained on a server accessible on the Internet. A user of the system operates a computer program (browser) which can display or process information in one or more of these formats. The browser can retrieve an initial file (page) of information from an internet connected computer system. The user can then instruct the browser to ‘follow’ links contained in the file, by using the information provided in the link to locate and retrieve the ‘linked’ information from either the original server or another server.

The usual representation of a link is a Uniform Resource Locator (URL) [T. Bemers-Lee: Uniform Resource Locators (URL), A Unifying Syntax for the Expression of Names and Addresses of Objects on the Network, RFC1738, RFC2396 1994-1998. http://www.ietf.org/rfc/rfc2396.txt]—a standardised encoding specifying a protocol (http, ftp, nntp & others), the Domain Name Service (DNS) name or Internet Protocol (IP) address of a server and a reference to the location (path) of the information on the server.

Table 1 is a chart illustrating an expression of the generic form of a URL for URLs encoding the http:, https:, ftp:, gopher: and similar schemes based upon a hierarchical path based information storage system. Typical URLs are presented to illustrate the generic form description.

TABLE 1

| | |
|---|---|
| 1 | s://N:p/P1/P2/-/Pn?Q#F |

Typical URLs matching the generic form

http://www.microsoft.com/business/investment/press_release.htm
ftp://ftp.netscape.com/new/navigator.exe
http://www.shopping.com/cart/add_item.php?item=apple
Key for Table 1

| | |
|---|---|
| S | protocol scheme - commonly http:, https:, ftp:, gopher:, nntp: |
| N:p | server name or address, optionally a protocol ‘port’, p |
| P1-Pn | a path (address) to a file of information (page), consisting of a |
| | plurality of path elements (parts) serparated by ‘/’ characters |
| Q | an optional query string, consisting of a plurality of names and |
| | values provided either by the server or the browser |
| F | an optional fragment identifier - a ‘sub-address’ referring |
| | to an area within a single file of information - this is normally |
| | processed only by the browser, and is not shown in most of the |
| | following tables |

The Internet WWW system is powerful and useful, so its mechanisms and standards have been widely adopted for private and corporate computer networks, known as intranets. Because these intranets usually contain confidential or proprietary information, they are usually not connected directly to the Internet—information on intranet servers is generally only available to other computers and users on the same intranet.

Various mechanisms have been developed to allow controlled access to information on intranet servers from computers outside the intranet, to allow public access to information, collaboration with external organizations and remote access for users who are not able to directly access the intranet, mobile workers, salespeople etc.

Although these exact mechanisms vary depending upon the protocols utilized by specific systems, they are generally known as firewalls, gateways or proxies.

The general function of a proxy or gateway is to act as an intermediary between the system requesting the information (client) and the system providing the information (server). A gateway is commonly defined as an intermediary which can convert an access request from one protocol to another to connect otherwise incompatible systems, or which can translate information from the server into a format which is acceptable to the client. Apart from protocol conversion, the intermediary system can fulfill a range of other functions such as security access control, language translation, annotation services, charging and accounting and data validation.

With the widescale deployment of browsers which understand the HTML information format and use the http protocol, a common requirement is for gateways which can convert information from various formats (including HTML) and protocols (including http) to the HTML format and deliver it using the http protocol.

When a browser retrieves information in a format that contains URLs (such as HTML), each URL contains details on where and how to access related (linked) information. When a Gateway retrieves a file (page) from a server on behalf of a client and returns it the client, the details of each link (URL) may be dynamically altered by the Gateway so that the URL specifies to the client that it should request the linked information from the Gateway, rather than directly from the server containing the original information. This allows the Gateway to continue to provide the appropriate conversion, access control or other service to the client browser. A Gateway that uses this mechanism may be termed a URL rewriting gateway or URL rewriting proxy.

Examples of gateways of the prior art that use the URL rewriting mechanism to provide a service to the client or server:

Delegate, 1994 [Yutaka Sato, Electrotechnical Laboratory (AIST, MITI), Tsukuba, Ibaraki 305, JAPAN—“Delegate—Development of a Protocol Mediation System”, TR-94-17, 1994 http://www.delegate.org]—a URL rewriting gateway which converts http, ftp, nntp & gopher to http protocol/HTML and provides functions for controlling access to intranet services. (English language description [Meyers, Steven, Computing Japan Magzine—“ETL: Laying the Groundwork for New Industrial Technologies—DeleGate—Multipurpose Protocol Mediation”, September 1995]).

The Anonymizer, 1995 [J. Boyan—“The Anonymizer—Protecting User Privacy On The Web”, December Communications, 1997 http://www.december.coni/cmc/mag/1997/sep/boyan.html]—a URL rewriting gateway which provides a privacy service for the client, by hiding information about the client from the server.

Babel Fish 1997, [Babel Fish—Altavista & Systran SA—1997 http://babelfish.altavista.com/]—a URL re-writing gateway which provides a (human) language translation servive—the service retrieves a page from an http server, translates between any two of English, French, German, Spanish or Italian and returns the translated page to the client. URLs are rewritten to allow the user to follow links and continue to have the gateway perform language translation.

Anti Censorship Proxy 1999, [Haselton, Bennet et al. ‘Anti-Censorship Proxy’—Technology for Circumventing Internet Censorship, Computers, Freedom & Privacy Conference Proceedings 1999 (Originally published at http://www.cfp99.org/program/papers/laselton.htm, currently archived at http://www.infowar.com/class_{—}1/00/class1_{—}042400e_j.shtm1]—an encrypted URL rewriting proxy for providing privacy enhanced web browser access.

Using a gateway to provide access control to intranet services is only one of the elements required to provide a secure environment in which a client and server can interact. One feature of most browser clients which adversely affects the security of processed information is the ‘history’ function. The browser maintains a list of URLs which have been accessed, including the name of the server, the name of the file (path) which was requested, the title of the requested information and the date and time when requested. The list is maintained even when the user has stopped using the browser, often for 30 days or more. This information can be extremely revealing to a third party who can access the history function.

Some gateways [Encrypted URLs—Anonymizer, 1998 http://www.anonymizer.com] offer a service which ‘encrypts’ or ‘conceals’ the URL information in each file provided to the client. The client can request an encrypted URL (see 6 in Table 2) from the Gateway, which can convert the URL back into un-encrypted form before requesting the appropriate file from the relevant server. Anyone examining the history function of the browser (or other audit trails) will see only the encrypted URL information, which should be meaningless.

Table 2 is a chart illustrating common URL encoding schemes used by URL rewriting gateways of the prior art. This chart provides the basis for the comparison chart provided in Table 3.

TABLE 2

| | Example | | |
|---|---|---|---|
| | Rewriting | | |
| | Type | Example Original URL | Example Modified URL |
| 2 | Simple | http://server1/foldera/page1.html | http://gateway1.com/simple/http://server1/ |
| | HTTP | | foldera/page1.html |
| | Gateway | | |
| 3 | Generic | s://N/-/P1/Pn | h://G/L1/-/Ln/s://N/P1/-/Pn |
| | Form | | |
| 4 | Hidden | http://server1/foldera/page1.html | http://gateway1.com/mountpoint/page1.html |
| | (Mounted) | | Note 14 |
| | Gateway | | |
| 5 | Generic | s://N/P1/-/Pn | h://G/L1/-Ln/N/P1/-/Pn |
| | Form | | |
| 6 | Encrypted | http://server1/foldera/page1.html | http://gateway1.com/crypt/FDoQGwsLCi4+ |
| | URL | | CCg+HQALBSMwDzwQGSIQBSYxGjsYKx0o |
| | Gateway | | |
| 7 | Generic | s://N/P1/-/Pn | h://G/L1/-/Ln/E |
| | Form | | |
| 8 | Simple | http://server1/foldera/price1.php?item= | http://gateway1.com/simple/http://server1/ |
| | Gateway | apple | foldera/price1.php?item=apple |
| | with Query | | |
| 9 | Generic | s://N/P1/-/Pn?Q | h://G/L1/-/Ln/s://N/P1/-/Pn?Q |
| | Form | | |
| 10a | Encrypted | http://server1/foldera/price1.php?item= | http://gateway1.com/crypt/LaZXcLCi4+CCg+ |
| | URL | apple | HPxcOlwDzwQGSIQBSYxGjsYKx0o |
| | Gateway | | |
| | with Query | | |
| 10b | Encrypted | http://server1/foldera/price1.php?item= | http://gateway1.com/crypt/LaZXcLCi4+CCg+ |
| | URL | apple | HPxcOlwDzwQGSIQBSYxGjsYKx0o?item= |
| | Gateway | | apple |
| | with Query | | |
| 11 | Generic | s://N/P1/-/Pn?Q | h://G/L1/-/Ln/E?Q |
| | Form | | |
| 12 | Encrypted | http://server1/$(foldervar)/page1.wml | http://gateway1.com/crypt/FH8s5fIusu3fkPku6zwz18876+ |
| | URL | | kwedb |
| | Gateway | | |
| | with page | | |
| | variable | | |
| 13 | Generic | s://N/P1/-/Pn | h://G/L1/-/Ln/E |
| | Form | | |

Key for Table 2

| | |
|---|---|
| h | protocol scheme for gateway - commonly http:, https: in the preferred embodiment, but may also be ftp:, gopher:, |
| | nttp: etc. |
| G | gateway name or address, possibly including a protocol port |
| L1-Ln | a path (address) local to the gateway, consisting of a zero or a plurality of path elements (parts) |
| h | protocol scheme for gateway - commonly http:, https: in the preferred embodiment, but may also be ftp:, gopher:, |
| | nttp: etc. |
| | separated by ‘/’ characters, possibly indicating which gateway service is required |
| E | encrypted string of characters encoding the Original URL. The prior art form of ‘E’ may include the ‘/’ |
| | character as a natural result of a possible character encoding scheme [N. Freed et al. - Multipurpose Internet |
| | Mail Extensions - RFC1341, RFC2045 1992-1996 http://www.ietf.org/rfc/rfc2045.txt] (or otherwise), but is not |
| | considered to be composed of a plurality of elements E1-En, as ‘E’ is treated as an opaque value by the |
| | browser and processed as a single path element by the encryption function of the gateway. [Encrypted URLs - |
| | Anonymizer, 1998 http://www.anonymizer.com] |
| Note 14 | A hidden (or ‘mounted’) gateway URL can be formed when the gateway contains an internal reference list indi- |
| | cating that, in this example, path element ‘mountpoint’ maps to ‘http://server2/folderb’ [Yutaka Sato, |
| | Electrotechnical Laboratory (AIST, MITI), Tsukuba, Ibaraki 305, JAPAN - “Delegate - Development of a |
| | Protocol Mediation System”, 1994 http://www.delegate.org/], [JP11177629A2 in the name of Nippon |
| | Telegraph and Telephone Corporation] |

The process of re-writing URLs has certain practical limitations. A major limitation has come about as newer, more sophisticated file formats are delivered to the browser. These newer formats include various kinds of ‘active’ content—program instructions which are delivered to the browser to control its actions, rather than simple static files to be displayed.

These formats (such as Javascript/ECMAscript, WMLScript, Java, ActiveX, Flash) may not contain URLs directly, but rather contain program instructions which, when executed by the browser, dynamically create a URL link from information provided either with the program or obtained from the user. In the general case, the Gateway is not able to recognise a URL, so the URL cannot be re-written to reference the Gateway service.

Sophisticated Gateways [iPlanet Portal Server, Sun-Netscape Alliance, 2000 http://www.iplanet.com] may include facilities to recognise and modify certain types of program code, but these facilities must be customised and modified for each variation of active content and server type, which can be complex and expensive and must be pre-configured for all possible servers and content which is to be processed by the Gateway.

The limitation is manageable for many Gateways, because many URLs (including those generated by active content) are specified as ‘relative’ URLs—although the Gateway may not recognise and modify the program code which creates a URL, the generated URL is specified as the ‘difference’ between the current URL known to the browser and the new, required URL. (Refer Table 3, 304 305 306 307 308 309 310) The browser calculates the ‘full’ URL from the requested relative URL and passes the request to the Gateway.

The limitation becomes much more serious when the technique of URL encryption is applied to the content. Because the browser can no longer understand the format of the encrypted URL, it is unable to correctly calculate a full URL from a relative URL, and so fails to request the correct information from the Gateway. (See examples 27, 28, 29 and 30).

Table 3 is a chart illustrating the defects of the rewritten URL encoding schemes of the prior art when employed with active and semi active content.

TABLE 3

| | Example | | Relative URL applied | |
|---|---|---|---|---|
| | Type | Base Encoded URL | by the active content | Resulting Encoded URL |
| 15 | No Gateway | http://server1/foldera/ | page2.html | http://server1/foldera/page2.html |
| | | page1.html | | |
| 16 | No Gateway | http://server1/foldera/ | folderb/page3.html | http://server1/foldera/folderb/ |
| | | page1.html | | page3.html |
| 17 | No Gateway | http://server1/foldera/ | . . . /page4.html | http://server1/foldera/page4.html |
| | | page1.html | | |
| 18 | No Gateway | http://server1/foldera/ | . . . / . . . / | http://server1/otherfolder/ |
| | | folderb/page3.html | otherfolder/ | page5.html |
| | | | page5.html | |
| 19 | Simple | http://gateway1.com/simple/ | page2.html | http://gateway1.com/simple/http:// |
| | Gateway | http://server1/foldera/ | | server1/foldera/page2.html |
| | | page1.html | | |
| 20 | Simple | http://gateway1.com/simple/ | folderb/page3.html | http://gateway1.com/simple/http:// |
| | Gateway | http://server1/foldera/ | | server1/foldera/folderb/page3.html |
| | | page1.html | | |
| 21 | Simple | http://gateway1.com/simple/ | . . . /page4.html | http://gateway1.com/simple/http:// |
| | Gateway | http://server1/foldera/ | | server1/page4.html |
| | | page1.html | | |
| 22 | Simple | http://gateway1.com/simple/ | . . . /. . . / | http://gateway1.com/simple/http:// |
| | Gateway | http://server1/foldera/ | otherfolder/ | server1/otherfolder/page5.html |
| | | folderb/page3.html | page5.html | |
| 23 | Hidden | http://gateway1.com/ | page2.html | http://gateway1.com/mountpoint/ |
| | Gateway | mountpoint/page1.html | | page2.html |
| 24 | Hidden | http://gateway1.com/ | folderb/page3.html | http://gateway1.com/mountpoint/ |
| | Gateway | mountpoint/page1.html | | folderb/page3.html |
| 25 | Hidden | http://gateway1.com/ | . . . /page4.html | http://gateway1.com/page4 |
| | Gateway | mountpoint/page1.html | | legal but incorrect URL |
| | | | | Note 32 |
| 26 | Hidden | http://gateway1.com/ | . . . / . . . / | http://gateway1.com/folderb/ |
| | Gateway | mountpoint/folderb/ | otherfolder/ | page3.html |
| | | page3.html | page5.html | legal but incorrect URL |
| | | | | Note 32 |
| 27 | Encrypted | http://gateway1.com/crypt/ | page2.html | http://gateway1.com/crypt/ |
| | URL | FDoQGwsLCi4+CCg+ | | page2.html |
| | Gateway | HQALBSMwDzwQGSIQBSYxGjsYKx0o | | legal but incorrect URL |
| | | | | Note 33 |
| 28 | Encrypted | http://gateway1.com/crypt/ | folderb/page3.html | http://gateway1.com/crypt/folderb/ |
| | URL | FDoQGwsLCi4+CCg+ | | page3.html |
| | Gateway | HQALBSMwDzwQGSIQBSYxGjsYKx0o | | legal but incorrect URL |
| | | | | Note 33 |
| 29 | Encrypted | http://gateway1.com/crypt/ | . . . /page4.html | http://gateway1.com/page4 |
| | URL | FDoQGwsLCi4+CCg+ | | legal but incorrect URL |
| | Gateway | HQALBSMwDzwQGSIQBSYxGjsYKx0o | | Note 33 |
| 30 | Encrypted | http://gateway1.com/crypt/ | . . . / . . . / | illegal URL |
| | URL | FDoQGwsLCi4+CCg+ | otherfolder/ | Note 34 |
| | Gateway | HQALBSMwDzwQGSIQBSYxGjsYKx0o | page5.html | |
| 31 | Encrypted | http//gateway1.com/crypt/ | /newfolder/page6.html | http://gateway1.com/newfolder/ |
| | URL | FDoQGwsLCi4+CCg+ | | page6.html |
| | Gateway | HQALBSMwDzwQGSIQBSYxGjsYKx0o | | legal but incorrect URL |
| | | | | Note 33 |

Notes for Table 3

| | |
|---|---|
| Note 32 | Cannot be decoded. |
| | These resulting URLs no longer contains the path element ‘mountpoint’ which the gateway requires as a key to |
| | lookup ‘http://server1/foldera’. Without this key, the gateway cannot decode and process the requested URL - |
| | this will result in a failed request for the client browser. |
| Note 33 | Cannot be decoded. |
| | These resulting URLs no longer contain an encrypted path element (Ec). Without this element, the gateway cannot |
| | decode and process the requested URL - this will result in a failed request for the client browser. |
| Note 34 | Cannot be decoded. |
| | This relative URL cannot be legally applied to the base URL, which means that the browser cannot generate any |
| | legal request for the gateway. |

A further class of limitations are apparent when considering active content which constructs URLs which-are not ‘relative’ to the the current base URL. When such ‘absolute path’ URLs are submitted to the gateway, they have lost all encrypted content and all additional information that the gateway may require to identify and decode the request. (See example 31 in Table 3)

Other limitations with encrypted URLs arise depending upon the precise instructions of the active content program—some programs search for specific key codes in an existing URL and use these as the basis for modifying or generating a new request URL. (For example, see Table 5)

Another class of content may be termed ‘semi-active’—the WML format, for example, allows content to include ‘page variables’—a placeholder for dynamically changing information—which, whilst not defining a program, is another mechanism which would commonly defeat URL rewriting and encryption mechanisms. (See 12 in Table 2)

A limitation also exists with URLs that contain a ‘query string’ element (See Table 1), separated from the path part of the Original URL by a question mark. This element encodes variable information used by a server when selecting the-appropriate content to be returned for a particular client request. The query element may be preserved by a browser when requesting a link, or it may be replaced with new values which are the result of user input. If the encrypted URL encrypts the query string element (10a in Table 2), then the browser will be unable to recognise the query string in those situations where active content wishes to modify the existing query string. If the query string element is not included in the encrypted element (10b in Table 2), then the content can update the query string element if required, but the contents of the query string (which may contain private information) are no longer protected by the encryption mechanism.

### SUMMARY OF THE INVENTION

In one form, although it need not be the only or indeed the broadest form, the invention resides in a method of encoding a remote record identifier to an encrypted rewritten record identifier including the steps of:

separating the remote record identifier into a base remote record identifier portion and a path and/or query portion;

encrypting said base remote record identifier portion to form an encrypted base remote record identifier portion;

processing said path and/or query portion to produce a substitute path and/or query element for each path and/or query;

merging the substitute path and/or query elements to produce a composite substitute path and/or query portion;

merging the composite substitute path and/or query portion with the encrypted base remote record identifier portion to produce a composite encrypted remote record identifier; and

merging the composite encrypted remote record identifier with gateway parameters to form said encrypted rewritten record identifier.

Suitably the invention also resides in a method of decoding an encrypted rewritten record identifier to a remote record identifier including the steps of:

separating gateway parameters from said encrypted rewritten record identifier to produce a composite encrypted remote record identifier;

splitting said composite encrypted remote record identifier into an encrypted base remote record identifier portion and a composite substitute path and/or query portion;

splitting the composite substitute path and/or query portion into substitute path and/or query elements;

processing each substitute path and/or query element to produce a path and/or query portion;

decoding said encrypted base remote record identifier portion to a base remote record identifier portion;

combining said base remote record identifier portion and said path and/or query portion to form said remote record identifier.

In a further form, the invention resides in a gateway apparatus for mediating communication between a client system and a server system, said gateway apparatus comprising.

means for establishing communication between said gateway apparatus and one or more communication networks;

a protocol engine for processing communication received or sent by said means for establishing communication and identifying encrypted remote record identifier elements;

a decode engine processing said encrypted remote record identifier elements to produce an unencrypted remote record identifier; and

a content retrieval means for retrieving content identified by said unencrypted remote record identifier.

Preferably the apparatus may further comprising an encode engine for encoding remote record identifiers.

In a yet further form the invention resides in a method of recovering encrypted elements and other elements of a rewritten record identifier when said rewritten record identifier lacks expected identifying elements, said method including the steps of:

determining that said rewritten record identifier lacks expected identifying elements and identifying present elements of said rewritten record identifier;

determining that said rewritten record identifier is presented with an accompanying referral record identifier;

extracting required encrypted and other elements from said referral record identifier;

constructing a composite rewritten record identifier composed of said encrypted and other elements of said referral record identifier and the identified elements of said rewritten record identifier; and

decoding said composite re-written record identifier in place of said re-written record identifier.

### BRIEF DESCRIPTION OF THE DRAWINGS

FIG. 1 is a block diagram showing a system where a client may access a server system through a gateway;

FIG. 2 is a data flow diagram showing the method of URL encoding of the invention in the basic case of a standard URL;

FIG. 3 is a data flow diagram showing the method of URL encoding of the invention in the case where pre-specified features and a query string are present in the URL;

FIG. 4 is a data flow diagram showing the method of URL decoding of the invention; and

FIG. 5 is a data flow diagram showing the method of recovering encrypted path and gateway information from URLs which have been modified using an absolute path.

### DETAILED DESCRIPTION OF THE INVENTION

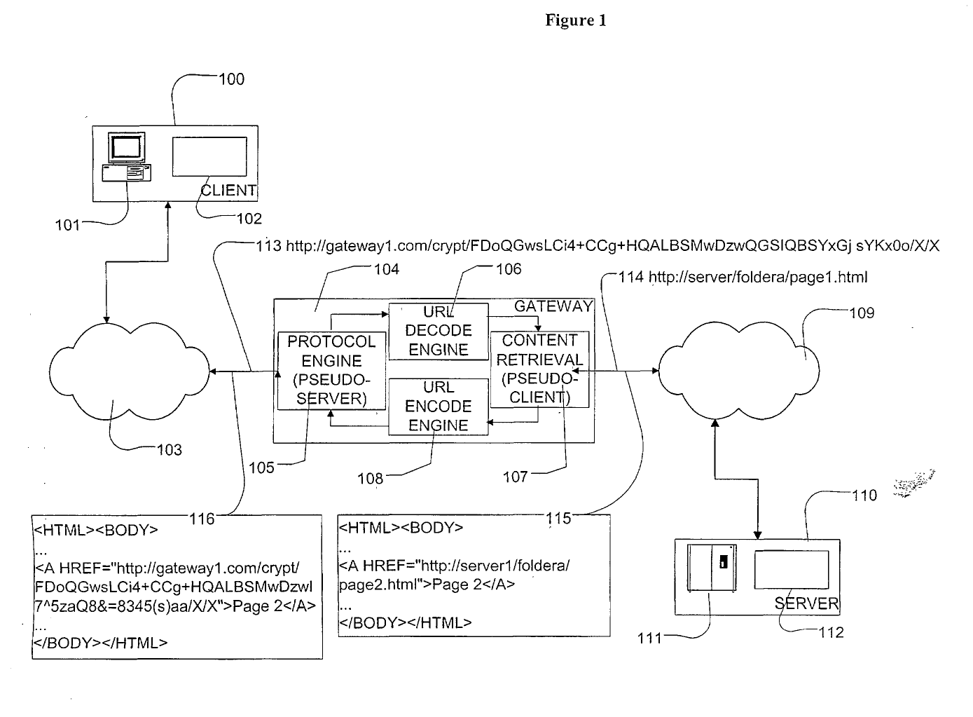

Referring to FIG. 1, there is shown a block diagram of an interconnected computer system network, comprising a plurality of client systems 100, server systems 110 and a gateway system 104 mediating communications between the other systems.

The client system 100 comprises a computer processing unit 101 and client software 102. The client software 102 makes requests for information to the computer system network by means of a communications network 103.

The server system 110 comprises a computer processing unit 111 and server software 112 which responds to requests from the computer system network received by means of a communications network 109.

To control access to the server system 110 by client systems 100 a gateway system 104 is provided to mediate communications between systems connected to communications networks 103 and 109. In the preferred embodiment communication network 103 comprises the Internet and communication network 109 comprises a private network intranet. In alternate embodiments both communications networks 103 and 109 may comprise identical networks or other commercial or private networks.

The gateway system 104 comprises a means 105 to receive and send information to client systems 100 via communications network 103, decode engine 106 and a means 107 to send and receive information to servers 110 via communications network 109.

When processing an information request, an encrypted URL 113 is submitted by the user of client system 100 through the client software 102 to the pseudo-server 105 on the gateway 104.

The URL decode engine 106 converts the encrypted URL into an unencrypted form 114, as described below, which is passed to the content retrieval process (pseudo-client) 107. The pseudo-client 107 acts on behalf of the real client 100 to request the URL from the server 110.

The server returns the requested information 115 which may contain further URLs—each a reference to another set of information.

The pseudo-client 107 passes the retrieved information 115 back to the pseudo-server 105 through the URL encode engine 108. The encode engine 108 replaces each URL in the original information 115 with an encoded encrypted URL in the information response sent to the client 116, as described in detail below.

The user of the client system 100 may instruct the client software 102 to select a new URL from the response 116 returned in the previous request and so repeat the sequence of request and response. The simple case is where the user directly requests a URL contained in the previous response 116, the encoded URL is used directly to submit to the gateway 104 for the next request.

In the case where the information returned to the client system includes active content which contains programmatic instructions to be interpreted by the client software 102, these instructions may specify how the client software should manipulate a received URL to construct a new URL before submitting a subsequent request.

Referring now to Table 4, there is shown a table illustrating the manipulations to a URL which may be made by active content. The simple case described above, where no manipulation is made by active content is shown first. Table 4 shows that all manipulations by Active Content produce valid results

TABLE 4

| | | Relative URL | |
|---|---|---|---|
| | | applied by the | |
| | Base Encoded URL | active content | Resulting Encoded URL |
| 401 | http://gateway1.com/crypt/ | | http://gateway1.com/crypt/ |
| | FDoQGwsLCi4+CCg+ | | FDoQGwsLCi4+CCg+ |
| | HQALBSMwDzwQGSIQBSYxGjsYKx0o/ | | HQALBSMwDzwQGSIQBSYxGjsYKx0o/ |
| | X/X | | X/X |
| 402 | http://gateway1.com/crypt/ | page2.html | http://gateway1.com/crypt/ |
| | FDoQGwsLCi4+CCg+ | | FDoQGwsLCi4+CCg+ |
| | HQALBSMwDzwQGSIQBSYxGjsYKx0o/ | | HQALBSMwDzwQGSIQBSYxGjsYKx0o/ |
| | X/X | | X/page2.html |
| 403 | http://gateway1.com/crypt/ | folderb/ | http://gateway1.com/crypt/ |
| | FDoQGwsLCi4+CCg+ | page3.html | FDoQGwsLCi4+CCg+ |
| | HQALBSMwDzwQGSIQBSYxGjsYKx0o/ | | HQALBSMwDzwQGSIQBSYxGjsYKx0o/ |
| | X/X | | folderb/page3.html |
| 404 | http://gateway1.com/crypt/ | . . . / | http://gateway1.com/crypt/ |
| | FDoQGwsLCi4+CCg+ | page4.html | FDoQGwsLCi4+CCg+ |
| | HQALBSMwDzwQGSIQBSYxGjsYKx0o/ | | HQALBSMwDzwQGSIQBSYxGjsYKx0o/ |
| | X/X | | page4.html |
| 405 | http://gateway1.com/crypt/ | . . . / . . . / | http://gateway1.com/crypt/ |
| | FDoQGwsLCi4+CCg+ | otherfolder/ | FDoQGwsLCi4+CCg+ |
| | HQALBSMwDzwQGSIQBSYxGjsYKx0o/ | page5.html | HQALBSMwDzwQGSIQBSYxGjsYKx0o/ |
| | X/X | | otherfolder/page5.html |
| 406 | http://gateway1.com/crypt/ | page2.html | http://gateway1.com/crypt/ |
| pre- | FDoQGwsLCi4+CCg+ | | FDoQGwsLCi4+CCg+ |
| specified | HQALBSMwDzwQGSIQBSYxGjsYKx0o/ | | HQALBSMwDzwQGSIQBSYxGjsYKx0o/ |
| feature | X/X.nsf/X | | X/X.nsf/page2.html |
| 407 | http://gateway1.com/crypt/ | page2.wml | http://gateway1.com/crypt/ |
| marker | FDoQGwsLCi4+CCg+ | $(user)=“bob” | FDoQGwsLCi4+CCg+ |
| character | HQALBSMwDzwQGSIQBSYxGjsYKx0o/ | Note 421 | HQALBSMwDzwQGSIQBSYxGjsYKx0o/ |
| | $(user)/X | | bob/page2.wml |
| 408 | http://gateway1.com/crypt/ | /newfolder/ | http://gateway1.com/newfolder/ |
| absolute | FDoQGwsLCi4+CCg+ | page6.html | page6.html |
| URL | HQALBSMwDzwQGSIQBSYxGjsYKx0o/ | | http://gateway1.com/crypt/ |
| | X/X | | FdoQGwsLCi4+CCg+ |
| | | | HQALBSMwDzwQGSIQBSYxGjsYKx0o/ |
| | | | newfolder/page6.html |
| | | | Note 422 |

Notes for Table 4

| | |
|---|---|
| 421 | Semi-active content may define page variables which may be interpolated into URLs using special marker charac- |
| | ters ‘$’ in this WML example). The resulting URL is dependant upon the relative URL and any page variables |
| | used in the URL. |
| 422 | This illustrates the ‘absolute path’ recovery mechanism described in the invention. The ‘HTTP Referer’ |
| | information supplied by the client is used to recover the encrypted path and gateway information elements and re- |
| | construct a valid request URL |

The various alternate manipulations 402, 403, 404, 405, 406, 407 show the range of relative URLs which may be applied by the active content to either the original URL or an encrypted URL supplied in the response 116.

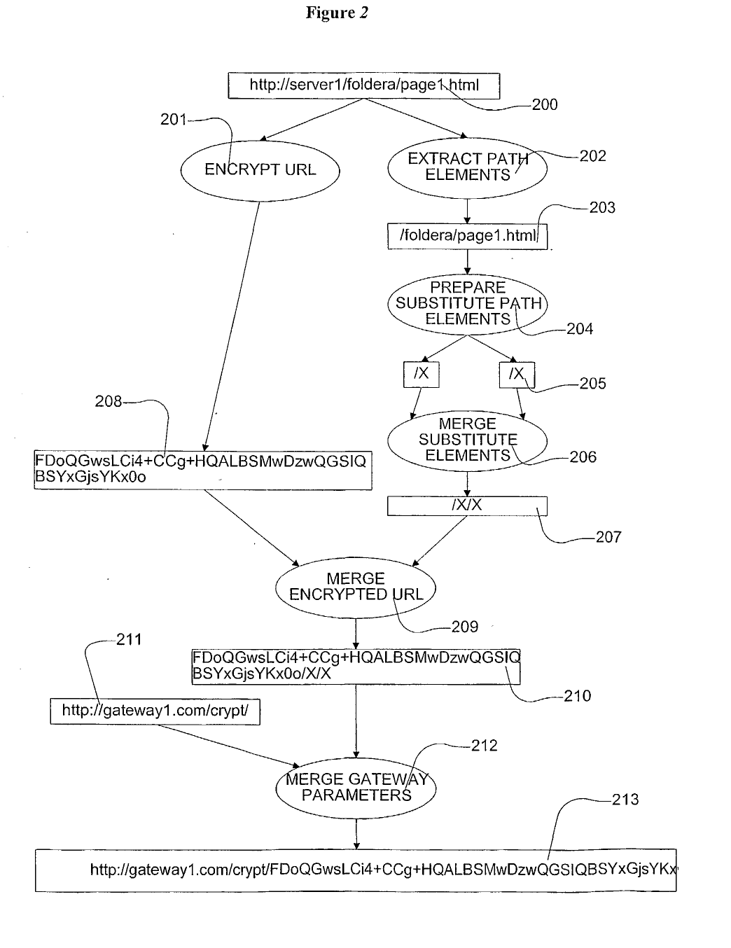

Referring now to FIG. 2, there is shown a data flow diagram illustrating the details of the steps of the method of encoding a URL into the output form, in the case where no pre-specified features are included in the input URL.

In the initial step, the input URL 200 undergoes two separate processes:

1) The input URL is encrypted by one of a-number of mechanisms 201, in the preferred embodiment the Blowfish symmetric encryption cipher is applied to the URL string and the output encoded in a modified form of base64 encoding to produce the encrypted URL 208;

2) The input URL 200 is processed 202 to extract the path elements of the URL 203. The path elements are processed 204 to produce a number of substitute path elements 205, as many substitute elements 205 are generated as there are path elements in the input URL 203. The substitute elements 205 are merged 206 to produce a composite substitute path 207.

In the subsequent steps, the encrypted URL 208 and the substitute path 207 are merged to provide a composite encrypted URL 210, which is then merged 212 with parameters identifying the location and type of the gateway 211 to produce the final encoded encrypted output URL 213.

This output URL 213 replaces the input URL 200 in the response information 116. The following pseudo-code describes the steps of the method illustrated in FIG. 2, the method of encoding a basic URL.

encode_basic(url)
{

encrypted_url = encrypt(url)
url_path = extract_path(url)
path_parts[] = split_at_slashes(url_path)
substitute_path=””
foreach path_part in path_parts[]
{

substitute_path=substitute_path+“/X”

}
if (last_character(url_path) == “/”)
{

substitute_path =substitute_path+“/”

}
output_url = encrypted_url+substitute_path
return output_url

}

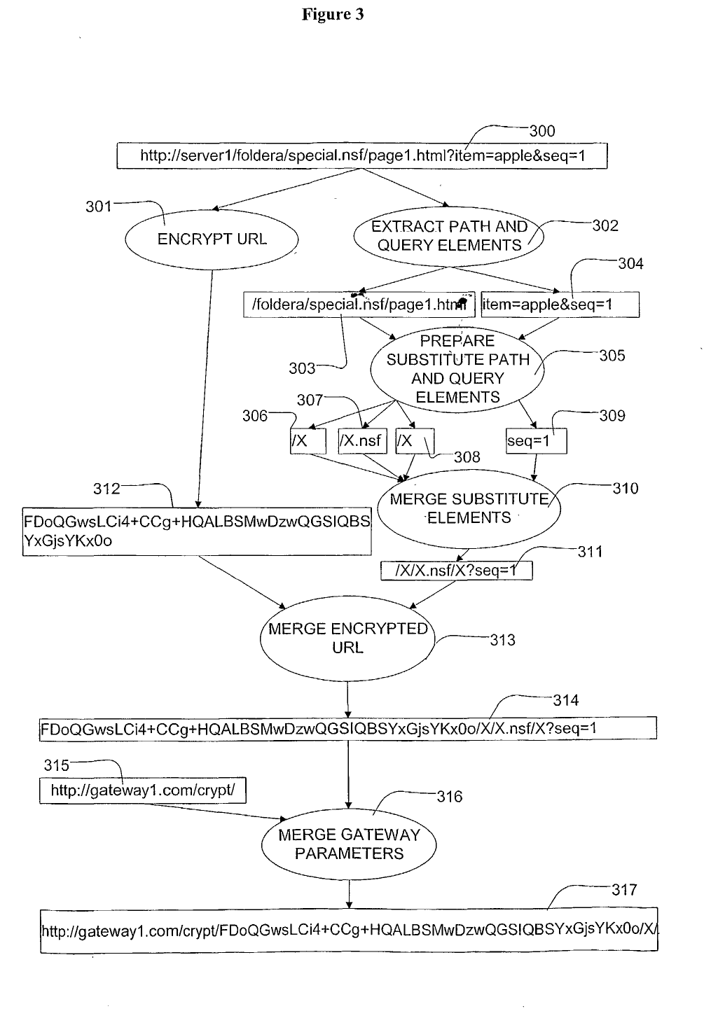

Referring now to FIG. 3, there is shown a data flow diagram illustrating the details of the steps of the method of encoding a URL into the output form in the case where a pre-specified feature and a pre-specified query string parameter are included in the input URL.

In the initial step, the input URL 300 undergoes two separate processes:

1) The input URL is encrypted by one of a number of mechanisms 301, in the preferred embodiment the Blowfish symmetric encryption cipher is applied to the URL string and the output encoded in a modified form of base64 encoding, to produce the encrypted URL 312

2) The input URL 300 is processed 302 to extract the path 303 and query elements 304 of the input URL 300. The path 303 element of the input is processed 305 to produce a number of substitute path elements 306, 307, 308, as many substitute elements 306, 307, 308 are generated as there are path elements in the input URL 303. Path elements matching the pre-specified pattern are substituted with elements which conform to the same pattern 307. The query element 304 is examined for pre-specified patterns and a substitute query element 309 is generated conforming to the same pattern. The substitute path 306, 307, 308 and query 309 elements are merged 310 to produce a composite substitute path 311.

In the subsequent steps, the encrypted URL 312 and the substitute path 311 are merged to provide a composite encrypted URL 314, which is then merged 316 with parameters identifying the location and type of the gateway 315 to produce the final encoded encrypted URL output 317.

The following pseudo-code describes the steps of the method illustrated in FIG. 3, the method of encoding a URL containing pre-specified path and query string elements. In this pseudo-code, the pre-specified elements are ‘.nsf’ in the path and ‘seq=’ in the query string.

encode_special(url)
{

encrypted_url = encrypt(url)
url_path = extract_path(url)
query_string = extract_query_string(url)
path_parts[] = split_at_slashes(url_path)
substitute_path=“”
foreach path_part in path_parts[]
{

if (contains_special(path_part,“.nsf”))
{

substitute_path = substitute_path+“/X.nsf”

} else {

substitute_path = substitute_path+“/X”

}

}
if (last_character(url_path) == “/”)
{

substitute_path = substitute_path+“/”

}
substitute_query=“”
if (defined(query_string) and

contains_special(query_string,“seq”))

{

substitute_query = “?seq=X”

}
output_url = encrypted_url+substitute_path+substitute_query
return output_url

}

The following pseudo-code describes the steps of the method of encoding a URL containing pre-specified marker characters that are recognized by semi-active content. This illustrates an alternative embodiment of FIG. 3. In this pseudo-code, the pre-specified marker character is the ‘$’ symbol, a symbol used to mark a page variable in the WML format. In the method illustrated in FIG. 3, the step of preparing substitute path and query elements 305 involves selecting the original path or query string element as the substitute element when a marker character is found.

encode_marker(url)
{

encrypted_url = encrypt(url)
url_path = extract_path(url)
query_string = extract_query_string(url)
path_parts[] = split_at_slashes(url_path)
substitute_path=“”
foreach path_part in path_parts[]
{

if (contains_special(path_part,“$”))
{

substitute_path = substitute_path+path_part

} else {

substitute_path = substitute_path+“/X”

}

}
if (last_character(url_path) == “/”)
{

substitute_path = substitute_path+“/”

}
substitute_query=“”
if (defined(query_string) and

contains_special(query_string,“$”))

{

substitute_query = “?”+query_string

}
output_url = encrypted_url+substitute_path+substitute_query
return output_url

}

Table 5 is a chart illustrating the URL encoding scheme of the invention when employed with active and semi-active content, showing that the invention remedies the defects of those schemes of the prior art.

TABLE 5

| | Example | | |
|---|---|---|---|
| | Type | Example Original URL | Example Encoded URL |
| 501 | Encrypted | http://server1/foldera/ | http://gateway1.com/crypt/FDoQGwsLCi4+ |
| | URL with | page1.html | CCg+HQALBSMwDzwQGSIQBSYxGjsYKx0o/ |
| | substitute path | | X/X |
| | elements | | |
| | concatenated # | | |
| | cpath | | |
| 502 | Generic Form | s://N/P1/-/Pn | H://G/L1/-/Ln/Ec/X1/-/Xn |
| 503 | Encrypted | http://server1/foldera/ | http://gateway1.com/crypt/FDoQGwsLCi4+ |
| | URL with | special.nsf/page1.html | CCg+HQALBSMwDzwQGSIQBSYxGjsYKx0o/ |
| | identifiable | | X/X.nsf/X |
| | path features # | | Note 521 |
| | notespath | | |
| 504 | Generic Form | s://N/P1/-/Pf/-/Pn | H://G/L1/-/Ln/Ec/X1/-/Xf/-Xn |
| 505 | Encrypted | http://server1/foldera/ | http://gateway1.com/crypt/FDoQGwsLCi4+ |
| | URL with | price1.php?item=apple&seq=1 | CCg+HQALBSMwDzwQGSIQBSYxGjsYKx0o/ |
| | identifiable | | X/X?seq=1 |
| | query string | | Note 522 |
| | features | | |
| 506 | Generic Form | s://N/P1/-/Pn?q1&qf | H://G/L1/-/Ln/Ec/X1/-/Xn?qf |
| 507 | Encrypted | http://server1/$(user)/ | http://gateway1.com/crypt/FDoQGwsLCi4+ |
| | URL with | page1.wml | CCg+HQALBSMwDzwQGSIQBSYxGjsYKx0o/ |
| | identifiable | | $(user)/X |
| | marker | | |
| | characters # | | |
| | WML macros | | |
| 508 | Generic Form | s://N/P1/-/Pm/-/Pn | H://G/L1/-/Ln/Ec/X1/-/Pm/-/Xn |
| 509 | Encrypted | http://server1/foldera/ | http://gateway1.com/crypt/FDoQGwsLCi4+ |
| | URL with | page1.wml?amount=$price | CCg+HQALBSMwDzwQGSIQBSYxGjsYKx0o/ |
| | identifiable | | X/X?amount=$price |
| | marker | | |
| | characters in | | |
| | query string | | |
| 510 | Generic Form | s://N/P1/-/Pn?Qm | H://G/L1/-/Ln/Ec/X1/-/Xn?Qm |
| 511 | URL with | http://server1/newfolder/ | http://gateway1.com/newfolder/page6.html+ |
| | missing | page6.html?item=apple | http referrer information |
| | encrypted | | |
| | elements and | | |
| | gateway | | |
| | parameters | | |
| 512 | Generic Form | s://N/P1/-/Pn?Q | H://G/P1/-/Pn?Q + |
| | | | http referrer information |

Key & Notes for Table 5

| | |
|---|---|
| Ec | An encrypted string of characters encoding the entire Original URL - In the preferred embodi- |
| | ment, the form ‘Ec’ does not include the ‘/’ character, although this is not an absolute |
| | requirement. |
| X1-Xn | Substitute (‘dummy’) path elements (parts), where the number of parts ‘n’ is the same (or |
| | greater than) the number of parts in the Original URL (P1/-/Pn). The substitute path element |
| | shown in example 501 is the ‘X’ character, though any character sequence may be used. In |
| | the preferred embodiment, the sequence consists of a single character which is unlikely to be |
| | the same as any path element P1-Pn. |
| Pf | An instance of a path element P1-Pn which contains a pre-specified feature |
| Xf | A substitute path element which contains the same pre-specified feature as element Pf |
| q1-qn | Sub elements of the query string Q |
| Qf | A sub element which contains a pre-specified feature |
| Pm | An instance of a path element P1-Pn which contains identifiable marker characters |
| Qm | A query sting element which contains identifiable marker characters |
| Note 521 | This example recognizes the feature ‘.nsf’ in the original URL and preserves the feature in the |
| | modified URL. |
| Note 522 | This example recognizes the feature ‘seq=’ in the query string of the original URL and |
| | preserves the feature in the modified URL. |

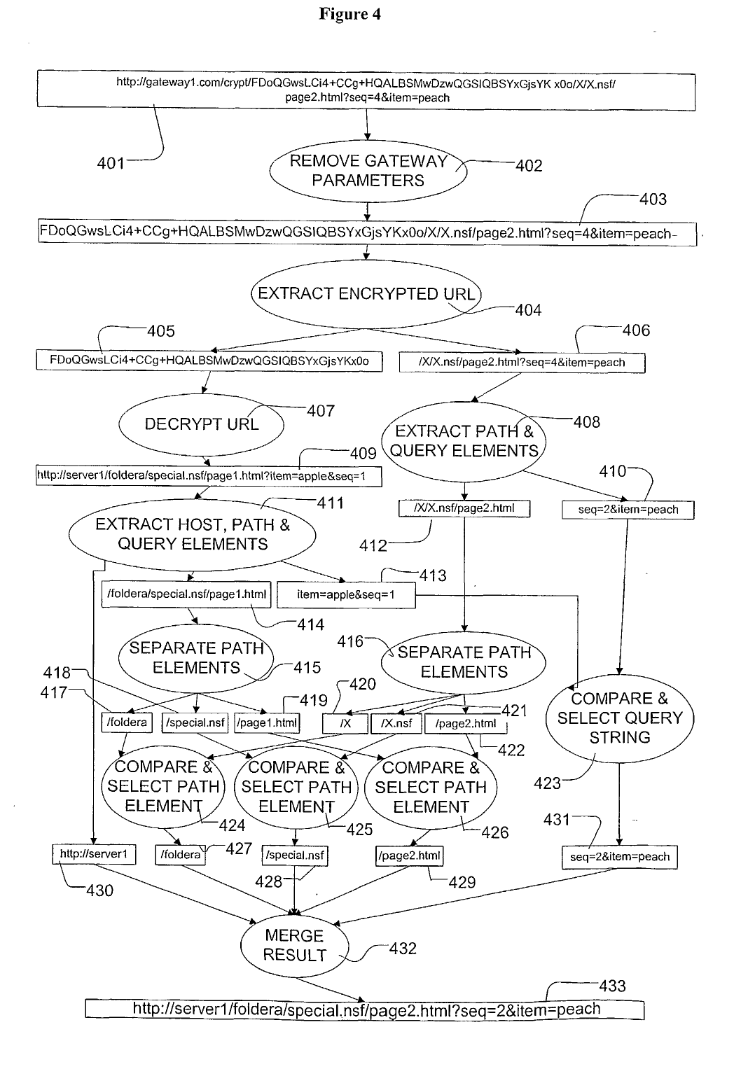

Referring now to FIG. 4, there is shown a data flow diagram illustrating the details of the steps of the method of decoding a URL presented in the encoded form of the invention. The encoded input URL 401 illustrates the results of the output URL 317 of FIG. 3 after manipulation by active content.

The encoded input URL 401 is processed 402 to remove elements identifying the gateway and gateway parameters to produce the composite encrypted URL 403. The composite encrypted URL is split into the encrypted URL 405 and the substitute element 406. The encrypted URL 407 is decrypted to produce the original base URL 409. The original base URL is processed 411 to produce the original host element 430, original path element 414 and original query string 413.

The substitute element 406 is processed 408 to produce the substitute path element 412 and substitute query string 410.

Each of the original path element 414 and the substitute path element 412 are 15, processed 415, 416 to separate them into individual original path elements 417, 418, 419 and substitute path elements 420, 421, 422. There are as many original path elements 417, 418, 419 as there are path elements in the original URL 409. There are as many substitute path elements 420, 421, 422 as there are substitute path elements in the substitute element 406.

Each substitute path element 420, 421, 422 is compared 424, 425, 426 with the corresponding original path element 417, 418, 419. Where the substitute path element has not been modified from the encoded encrypted URL output to the client 317, the original path elements 417, 418 are selected 424, 425 as output elements 427, 428. Where the substitute path element has been modified from or appears in addition to the encoded encrypted URL output to the client 317, the substitute path element 422 is selected 426 as an output element 429 and the original path element 419 is discarded.

The substitute query string 410 is compared with the original query string 413. If the substitute query string is present it is selected as the output query string 431. If no substitute query string is present, the original query string 413 is selected as the output query string 431.

The original host element 430, the selected output path elements 427, 428, 429 and the selected output query string 431 are combined 432 to produce the final output decoded URL 433 which is passed to the pseudo-client 107.

The following pseudo-code implements the method illustrated in FIG. 4, for decoding a URL to produce the original input URL.

decode_url(input_url)
{

input_url = remove_gateway_parameters(url)
encrypted_url = extract_encrypted_url(input_url)
substitute_element = extract_substitute_element(input_url)
base_url = decrypt(encrypted_url)
original_host = extract_host(base_url)
original_path = exract_path(base_url)
original_query_string = extract_query_string(base_url)
substitute_path = extract_path(substitute_element)
substitute_query_string = extract_query_string(substitute_element)
substitute_path_parts[] = split_at_slashes(substitute_path)
original_path_parts[] = split_at_slashes(original_path)
new_path = “”
foreach substitute_part in substitute_path_parts[]
{

original_part = next(original_path_parts[])

if (defined(original_part) and

( substitute_part == “X” or substitute_part == “X.nsf”))

{

new_path = new_path + “/” + original_part

} else {

new_path = new_path + “/” + substitute_part

}

}
if (last character(input_url) == “/”)
{

new_path = new_path+“/”

}
if (defined(substitute_query_string))
{

new_query_string = substitute_query_string

} else {

new_query_string = original_query_string

}
output_url = original_host + new_path + new_query_string
return output_url

}

Table 6 is a chart illustrating that the manipulations shown in Table 5 are successfully decoded by the URL decoding scheme of the invention, without being affected by the defects illustrated in Table 3.

TABLE 6

| | Encoded URL | Decoded URL |
|---|---|---|
| 601 | http://gateway1.com/crypt/ | http://server1/foldera/page1.html |
| | FDoQGwsLCi4+CCg+ | |
| | HQALBSMwDzwQGSIQBSYxGjsYKx0o/ | |
| | X/X | |
| 602 | http://gateway1.com/crypt/ | http://server1/foldera/page2.html |
| | FDoQGwsLCi4+CCg+ | |
| | HQALBSMwDzwQGSIQBSYxGjsYKx0o/ | |
| | X/page2.html | |
| 603 | http://gateway1.com/crypt/ | http://server1/folderb/page3.html |
| | FDoQGwsLCi4+CCg+ | |
| | HQALBSMwDzwQGSIQBSYxGjsYKx0o/ | |
| | folderb/page3.html | |
| 604 | http://gateway1.com/crypt/ | http://server1/page4.html |
| | FDoQGwsLCi4+CCg+ | |
| | HQALBSMwDzwQGSIQBSYxGjsYKx0o/ | |
| | page4.html | |
| 605 | http://gateway1.com/crypt/ | http://server1/ptherfolder/page5.html |
| | FDoQGwsLCi4+CCg+ | |
| | HQALBSMwDzwQGSIQBSYxGjsYKx0o/ | |
| | otherfolder/page5.html | |
| 606 | http://gateway1.com/crypt/ | http://server1/foldera/special.nsf/page2.html |
| | FDoQGwsLCi4+CCg+ | |
| | HQALBSMwDzwQGSIQBSYxGjsYKx0o/ | |
| | X/X.nsf/page2.html | |
| 607 | http://gateway1.com/crypt/ | http://server1/bob/page2.wml |
| | FDoQGwsLCi4+CCg+ | |
| | HQALBSMwDzwQGSIQBSYxGjsYKx0o/ | |
| | bob/page2.wml | |

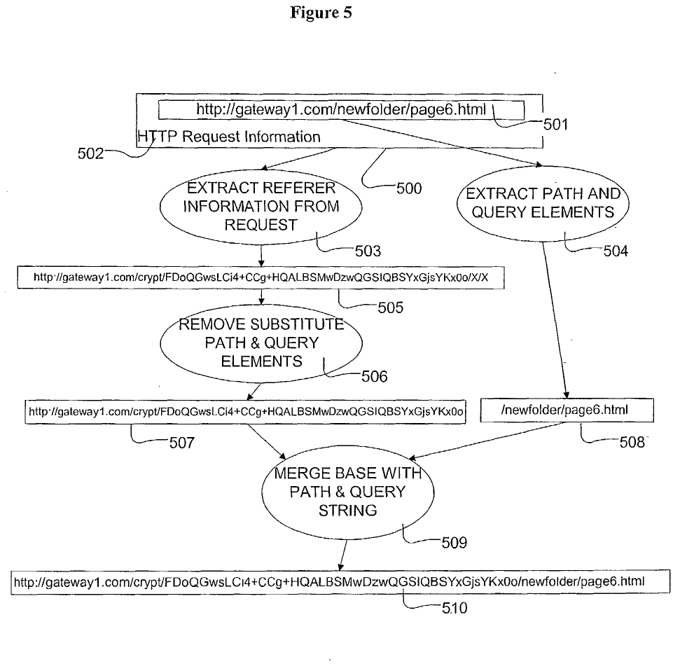

Referring now to FIG. 5, there is shown a data flow diagram illustrating the detail of the steps of the method of recovering encrypted path and gateway information from URLs which are presented by the client system without these elements. This situation occurs when active content attempts to specify an absolute path element when manipulating a URL, as illustrated in Table 5 at 508.

The input URL 501 does not contain any encrypted path component or gateway identifying information. The gateway can identify this situation, in the preferred embodiment, this case is detected by the ‘404 NOT FOUND’ error detection mechanism—and determine that it should handle this condition using the method illustrated in FIG. 5.

The input client request 500 comprises of the said input URL 501 and other additional-HTTP request information 502. One element of the HTTP request information is extracted 503 to provide the ‘Referrer’ element 505. The Referrer element is processed 506 to remove the substitute path and query elements, leaving the base encrypted URL and gateway information 507.

The input URL 501 is processed 504 to extract the input path and any query elements 508.

The base encrypted URL and gateway information 507 is merged 509 with the input path and query elements 508 to provide a complete input URL 510. This input URL 510 represents the corrected form of the encoded URL which is provided as the input URL 401 to the steps illustrated in FIG. 4.

The following pseudo-code implements the method illustrated in FIG. 5, the method of recovering encrypted path and gateway information from URLs which are presented by the client system without these elements.

recover_url(url,input_request_information)
{

referer = extract_http_header(

input_request_information,“Referer”)

base_encrypted_url = extract_host(url) +

extract_gateway_params(url) +
extract_encrypted_element(url)

input_path_and_query = extract_path_and_query_string(input_url)
complete_input_url = base_encrypted_url + input_path_and_query
return complete_input_url

}

It will be appreciated that, unlike the prior art, the invention comprises an apparatus and method of encoding for both re-writing and encrypting URLs that provides the privacy and security benefits of encrypted URLs whilst retaining compatibility with the use of relative URLs in active content. The invention also provides an apparatus and method of decoding the re-written encrypted URLs after manipulation by a browser to recover the original or new URL.

Furthermore, an enhancement of the invention provides an apparatus and method for recovering encrypted URL information and gateway information from requests where active content has modified a re-written encrypted URL in such a way as to remove the encrypted path element or other gateway information. The invention maintains compatibility with the class of active content which searches for specific features in URLs whilst minimizing any loss of the privacy provided by URL encryption. The invention also maintains compatibility with the page variable mechanism used by the class of semi-active content.

Unlike prior art systems, the invention optimally encrypts URLs which contain a query string element, which generally protects the content of the query string whilst allowing the browser to submit an alternative query string when required to do so via user input.

Throughout the specification the aim has been to describe embodiments of the invention without limiting the invention to any specific combination alternate features.

1. A method of encoding a remote record identifier to an encrypted rewritten record identifier including the steps of:
separating the remote record identifier into a base remote record identifier portion and a path and/or query portion;
encrypting said base remote record identifier portion to form an encrypted base remote record identifier portion;
processing said path and/or query portion to produce a substitute path and/or query element for each path and/or query;
merging the substitute path and/or query elements to produce a composite substitute path and/or query portion;
merging the composite substitute path and/or query portion with the encrypted base remote record identifier portion to produce a composite encrypted remote record identifier; and
merging the composite encrypted remote record identifier with gateway parameters to form said encrypted rewritten record identifier.

2. The method of claim 1 wherein the step of processing said path and/or query portion involves substituting each path and/or query having a pre-specified pattern with a substitute path and/or query element conforming to the same pattern.

3. The method of claim 1 wherein the gateway parameters include location and type.

4. A method of decoding an encrypted rewritten record identifier to a remote record identifier including the steps of:
separating gateway parameters from said encrypted rewritten record identifier to produce a composite encrypted remote record identifier;
splitting said composite encrypted remote record identifier into an encrypted base remote record identifier portion and a composite substitute path and/or query portion;
splitting the composite substitute path and/or query portion into substitute path and/or query elements;
processing each substitute path and/or query element to produce a path and/or query portion;
decoding said encrypted base remote record identifier portion to a base remote record identifier portion;
combining said base remote record identifier portion and said path and/or query portion to form said remote record identifier.

5. The method of claim 4 wherein the step of processing each substitute path and/or query element involves substituting each path and/or query element having a pre-specified pattern with a substitute path and/or query conforming to the same pattern.

6. The method of claim 4 wherein the gateway parameters include location and type.

7. A method of mediating encrypted communication between a client system and a server system including the steps of:
at a client system, encoding a remote record identifier to an encrypted rewritten record identifier by:
separating the remote record identifier into a base remote record identifier portion and a path and/or query portion;
encrypting said base remote record identifier portion;
processing said path and/or query portion to produce a substitute path and/or query element for each path and/or query;
merging the substitute path and/or query elements to produce a composite substitute path and/or query portion;
merging the composite substitute path and/or query portion with the encrypted base remote record identifier portion to produce a composite encrypted remote record identifier; and
merging the composite encrypted remote record identifier with gateway parameters to form said encrypted rewritten record identifier;
transmitting the encrypted rewritten record identifier to a gateway system;
at a gateway system, decoding the encrypted rewritten record identifier to the remote record identifier by:
separating gateway parameters from said encrypted rewritten record identifier to produce a composite encrypted remote record identifier;
splitting said composite encrypted remote record identifier into an encrypted base remote record identifier portion and a composite substitute path and/or query portion;
splitting the composite substitute path and/or query portion into substitute path and/or query elements;
processing each substitute path and/or query element to produce a path and/or query portion;
decoding said encrypted base remote record identifier portion to a base remote record identifier portion;
combining said base remote record identifier portion and said path and/or query portion to form said remote record identifier;
retrieving from said server system information identified by said remote record identifier; and forwarding the information to the client system.

8. The method of claim 7 further including the step of encrypting said information identified by said remote record identifier prior to forwarding the information to the client system.

9. The method of claim 8 further including the step of encoding remote record identifiers in the information identified by said remote record identifier.

10. A gateway apparatus for mediating communication between a client system and a server system, said gateway apparatus comprising:
means for establishing communication between said gateway apparatus and one or more communication networks;
a protocol engine for processing communication received or sent by said means for establishing communication and identifying encrypted remote record identifier elements;
a decode engine processing said encrypted remote record identifier elements to produce an unencrypted remote record identifier; and
a content retrieval means for retrieving content identified by said unencrypted remote record identifier.

11. The apparatus of claim 20 further comprising an encode engine for encoding remote record identifiers.

12. A method of recovering encrypted elements and other elements of a rewritten record identifier when said rewritten record identifier lacks expected identifying elements, said method including the steps of:
determining that said rewritten record identifier lacks expected identifying elements and identifying present elements of said rewritten record identifier;
determining that said rewritten record identifier is presented with an accompanying referral record identifier;
extracting required encrypted and other elements from said referral record identifier;
constructing a composite rewritten record identifier composed of said encrypted and other elements of said referral record identifier and the identified elements of said rewritten record identifier; and
decoding said composite re-written record identifier in place of said re-written record identifier.
